(19) United States
(12) Patent Application Publication
(10) Pub. No.: US 2018/0053102 A1
(43) Pub. Date: Feb. 22, 2018

(54) Individualized Adaptation of Driver Action Prediction Models

(71) Applicant: TOYOTA JIDOSHA KABUSHIKI KAISHA, Toyota-shi (JP)

(72) Inventors: Eric Martinson, Sunnyvale, CA (US); Oluwatobi Olabiyi, Mountain View, CA (US); Kentaro Oguchi, Menlo Park, CA (US)

(21) Appl. No.: 15/362,799

(22) Filed: Nov. 28, 2016

Related U.S. Application Data
(63) Continuation-in-part of application No. 15/238,646, filed on Aug. 16, 2016.

(51) Int. Cl. G06N 5/04; B60R 16/023; G08G 1/01; G06N 99/00

(52) U.S. Cl. CPC G06N 5/04; B60R 16/0232; G06N 99/005; G08G 1/0116; G08G 1/0137; G08G 1/0112

(57) ABSTRACT

By way of example, the technology disclosed by this document may be implemented in a method that includes aggregating local sensor data from vehicle system sensors, detecting a driver action using the local sensor data, and extracting features related to predicting driver action from the local sensor data during the operation of the vehicle. The method may include adapting a stock machine learning-based driver action prediction model to a customized machine learning-based driver action prediction model using one or more of the extracted features and the detected driver action, the stock machine learning-based driver action prediction model initially generated using a generic model configured to be applicable to a generalized driving populace. In some instances, the method may also include predicting a driver action using the customized machine learning-based driver action prediction model and the extracted features.

### CROSS-REFERENCE TO RELATED APPLICATIONS

The present application a continuation-in-part of U.S. patent application Ser. No. 15/238,646, entitled “Integrative Cognition of Driver Behavior,” filed Aug. 16, 2016, the entire contents of which is incorporated herein by reference. This application is related to co-pending U.S. application Ser. No. 15/362,720, entitled “Efficient Driver Action Prediction System Based on Temporal Fusion of Sensor Data Using Deep (Bidirectional) Recurrent Neural Network,” filed Nov. 28, 2016, the contents of which are hereby incorporated herein by reference.

### BACKGROUND

The present disclosure relates to machine learning. In particular, the present disclosure relates to predicting the actions of users as they relate to a moving platform. In some instances, the present disclosure relates to adapting previously trained models to specific circumstances using local data.

Traffic accidents kill over 1.2 million people per year worldwide, and more than 30,000 people die in US alone annually according to the reports from World Health Organization's global status report on road safety and National Highway Traffic Safety Administration. Many of the accidents are caused by risky driving behaviors, which could be preventable if these behaviors could be predicted and drivers warned, and/or compensation strategies were generated in advance, even just a few seconds. Generally, current state-of-the-art driver assistance solutions are unable to provide high-precision driver behavior prediction in a cost-effective manner due to the limitations in their systems/models.

Advance driver assistance systems can benefit from an improved and adaptable driver action prediction (DAP) system. Many of the safety features in today's vehicles, such as automatic breaking and steering, have a mandatory driver response time requirement before the feature can be fully and safely engaged. Being able to predict a driver action a few seconds ahead of the action may greatly improve the efficiency and usefulness of such advance driver assistance systems. In particular, an advance driver assistance system that can predict actions further in advance and with greater accuracy will enable new advance driver assistance system functionality, such as automatic turn and braking signals, which can further improve road safety.

Past solutions have required prior data collection (e.g., using “big data”) to create a generalized model that can predict arbitrary driver actions. However, while the recognition or detection of a driver action is universal, predicting a driver action ahead of time is highly dependent on individual driving behavior and the environment in which a driver is driving. Additionally, computer learning models, especially neural networks, are data-driven solutions, and making accurate predictions requires significant amounts of training data for the situations that the computer learning model is likely to encounter. Accordingly, an extremely large training database would be required to cover every potential user in every potential situation. Accordingly, an adaptable model that can benefit from both past data collection and adapt to a custom set of circumstances is needed.

Some existing approaches attempt to predict driver behavior using only limited data related to driving. For instance, He L., Zong C., and Wang C., “Driving intention recognition and behavior prediction based on a double-layer hidden Markov model,” Journal of Zhejiang University-SCIENCE C (Computers & Electronics), Vol. 13 No 3, 2012, 208-217, describes a double layer Hidden Markov Model (HMM) that includes a lower layer multi-dimensional Gaussian HMM performing activity recognition and an upper layer multi-dimensional discrete HMM performing anticipation. However, this model only considers Controlled Area Network (CAN) data such as breaking, accelerating, and steering, and fails to account for important features that affect driving, such as road conditions, location familiarity and steering pattern of a driver. Accordingly, this model, as well as other MINI based solutions lack sufficient complexity to model differences between individual drivers and, as such, these solutions can only make predictions about events that have occurred many times in the past and are not very useful for emergency situations. Additionally, extending these models to a System of Experts solution makes real-time adaptation to a driver nearly impossible while still lacking sufficient complexity to learn from very large datasets.

Another common, but less robust machine learning method for driver action prediction includes using Hidden Markov Models (HMM). For instance, Ohn-Bar, E., Tawari, A., Martin, S., Trivedi, M. “Predicting Driver Maneuvers by Learning Holistic Features”, IEEE Intelligent Vehicles Symposium 2014, provides a driver action prediction system that does not adapt to individual drivers, is generic in scope, and limited in predictive accuracy.

Some approaches require feature extraction before driver behavior recognition and prediction. For instance, Jain, A., Koppula S., Raghavan B., Soh S., and Saxena A., “Car that knows before you do: anticipating maneuvers via learning temporal driving models,” ICCV, 2015, 3182-3190, considers an elaborate multi-sensory domain for predicting a driver's activity using a Auto-regressive Input-Output MINI (AIO-HMM). In a first step, Jain describes extracting features from input sensor data, such as high-level features from a driver-facing camera to detect a driver's head pose, object features from a road-facing camera to determine a road occupancy status, etc. However, Jain's approach requires a substantial amount of human involvement, which makes it impractical for dynamic systems and possibly dangerous. Further, the number of sensory inputs considered by Jain is not representative of typical human driving experiences, and the model is unable to consider important features affecting a driver's action, such as steering patterns, local familiarity, etc.

Some approaches, such as Jain A., Koppula S., Raghavan B., Soh S., and Saxena A., “Recurrent neural networks for driver activity anticipation via sensory-fusion architecture,” arXiv:1509.05016v1 [cs.CV], 2015, describe using a generic model developed with data from a population of drivers. However, a model like Jain's is unable to adequately model and predict driver behavior and thus reduce the risk of an accident from occurring. In particular, Jain's model is based on a Long-Short Term Memory Recurrent Neural Network (LSTM-RNN), and is trained using a backpropagation through time (BPTT) algorithm. Among the most significant limitations of Jain's solutions are that the training data is constructed by hand and does not improve predictions of driver behavior from observations of a current driver.

Some approaches have used a System of Experts, as in Jain, but have attempted to provide an update process for training the prediction system. Among such past attempts are described in Hisaie, N, Yamamura, T (Nissan) “Driving behavior pattern recognition device” JP4096384B2, 2008-06-0, and Kuge, N., Kimura, T. (Nissan) “Driving intention estimation system, driver assisting system, and vehicle with the system”, U.S. Pat. No. 7,809,506B2, 2010 Oct. 2005. These solutions apply a weight to the outputs of each expert and the weights are incremented when a comparison of predicted action and recognized action match, thereby emphasizing the weight of that expert in the future. This solution is called boosting in machine learning and, although effective for fusing a System of Experts, it does not improve scalability to very large datasets, because it does not retrain models to represent anything new in the data. Additionally, this approach results in an unstable algorithm when there is significant noise in the labeled actions, as may be expected from nuanced driver actions (e.g., changing lanes are difficult to separate from curves in a road or shifts in lanes).

Accordingly, there is a need for a driver action prediction system that is both high performance and adaptable.

### SUMMARY

The specification overcomes the deficiencies and limitations of the approaches described in the Background at least in part by providing novel technology for updating driver action prediction models by recognizing actions in live sensing and improving performance with respect to individual drivers and environments.

According to one innovative aspect of the subject matter described in this disclosure, a method may include aggregating local sensor data from a plurality of vehicle system sensors during operation of vehicle by a driver; detecting, during the operation of the vehicle, a driver action using the local sensor data; and extracting, during the operation of the vehicle, features related to predicting driver action from the local sensor data. The method may include adapting, during operation of the vehicle, a stock machine learning-based driver action prediction model to a customized machine learning-based driver action prediction model using one or more of the extracted features and the detected driver action, the stock machine learning-based driver action prediction model initially generated using a generic model configured to be applicable to a generalized driving populace. Additionally, in some implementations, the method may include predicting a driver action using the customized machine learning-based driver action prediction model and the extracted features.

According to another innovative aspect of the subject matter described in this disclose, a system may include one or more computer processors and one or more non-transitory memories storing instructions that, when executed by the one or more computer processors, cause the computer system to perform operations comprising: aggregating local sensor data from a plurality of vehicle system sensors during operation of vehicle by a driver; detecting, during the operation of the vehicle, a driver action using the local sensor data; and extracting, during the operation of the vehicle, features related to predicting driver action from the local sensor data. The operations may also include adapting, during operation of the vehicle, a stock machine learning-based driver action prediction model to a customized machine learning-based driver action prediction model using one or more of the extracted features and the detected driver action, the stock machine learning-based driver action prediction model initially generated using a generic model configured to be applicable to a generalized driving populace. Additionally, in some implementations, the operations may include predicting a driver action using the customized machine learning-based driver action prediction model and the extracted features.

Other aspects include corresponding methods, systems, apparatus, and computer programs, configured to perform various actions and/or store various data described in association with these aspects. These and other aspects, such as various data structures, may be encoded on tangible computer storage devices. For instance, one or more of these aspects may include one or more of the following features: that detecting the driver action using the local sensor data includes labeling the driver action; that extracting the features related to predicting driver action from the local sensor data includes generating one or more extracted features vectors including the extracted features; synchronizing the labeled driver action with the one or more extracted features vectors; determining a driver action prediction duration, wherein the features are extracted from the local sensor data over the driver action prediction duration; that synchronizing the labeled driver action with the one or more extracted feature vectors includes labeling the features of the one or more extracted feature vectors and determining which of the extracted features from the one or more extracted feature vectors to use in adapting the machine learning-based driver action prediction model; that the local sensor data includes one or more of internal sensor data from sensors located inside a cabin of the vehicle, external sensor data from sensors located outside of the cabin of the vehicle, and network-communicated sensor data from one or more of adjacent vehicles and roadway infrastructure equipment; that the local sensor data includes one or more of braking data describing braking actions by the driver, steering data describing steering actions by the driver, turn indicator data describing turning actions by the driver, acceleration data describing acceleration actions by the driver, control panel data describing control panel actions by the driver, vehicle-to-vehicle data, and vehicle-to-infrastructure data; that adapting the stock machine learning-based driver action prediction model includes iteratively updating the stock machine learning-based driver action prediction model using sets of newly received local sensor data; that aggregating the local sensor data includes receiving localized data from one or more other adjacent vehicles reflecting local conditions of a surrounding environment surrounding the vehicle; and that adapting the stock machine learning-based driver action prediction model includes training the stock machine learning-based driver action prediction model using the localized data.

According to yet another innovative aspect of the subject matter described in this disclosure, a method comprises receiving a stock machine learning-based driver action prediction model prior to operation of a vehicle, the stock machine learning-based driver action prediction model having been initially generated using one or more generic training examples, the one or more generic training examples being configured to be applicable to a generalized set of users; detecting a driver action of a specific user during the operation of the vehicle using local sensor data; and extracting, during the operation of the vehicle, features related to the driver action from the local sensor data. The method may also include generating, during the operation of the vehicle, training examples using the extracted features related to the driver action and the extracted features; generating, during the operation of the vehicle, a customized machine learning-based driver action prediction model by updating the stock machine learning-based driver action prediction model using the training examples; and predicting, during the operation of the vehicle, a future driver action using the customized machine learning-based driver action prediction model.

These and other implementations may further include one or more of the following features: that the stock machine learning-based driver action prediction model is a neural network-based computer learning model; that detecting the driver action includes generating a recognized driver action label using a machine learning based-recognition model; linking the customized machine learning-based driver action prediction model to the specific user; and providing the customized machine learning-based driver action prediction model to a remote computing device of a second vehicle for use in predicting future driver actions of the specific user relating the second vehicle.

Numerous additional features may be included in these and various other implementations, as discussed throughout this disclosure.

The technology of the disclosure is advantageous over other existing solutions in a number of respects. By way of example and not limitation, the technology described herein enables a computing system to provide a driver action prediction system that is both able to be pre-trained and may be adapted to a custom set of circumstances. For example, online or continuous adaptation allows a driver action prediction system to overcome the data collection barriers described in the Background by improving on a driver action prediction model trained by the factory using locally acquired data. For example, some of the benefits that may be provided by implementations of the technology described herein include the capability to incorporate real-time detection of driver action (e.g., thereby limiting human involvement in labeling and creating training examples), learning that is robust to classification noise in large datasets, and the capability of updating existing driver action prediction models with driver specific data.

The features and advantages described herein are not all-inclusive and many additional features and advantages will be apparent to one or ordinary skill in the art in view of the figures and description. Moreover it should be noted that the language used in the specification has been selected for readability and instructional purposes and not to limit the scope of the inventive subject matter.

The disclosure is illustrated by way of example, and not by way of limitation in the figures of the accompanying drawings in which like reference numerals are used to refer to similar elements.

### BRIEF DESCRIPTION OF THE DRAWINGS

FIG. 1 is a block diagram of an example system for modeling driver behavior.

FIG. 2 is a block diagram of an example computing device.

FIG. 3A is a block diagram of an example deployment of the advance driver assistance engine.

FIG. 3B is a block diagram of an example implementation for updating a model using the advance driver assistance engine.

FIG. 4 is a flowchart of an example method for individually adapting driver action prediction models.

FIGS. 5A-E illustrate various different examples of sensor data.

### DESCRIPTION

The technology described herein may efficiently and effectively model a driver's behavior based on the sensor data capturing the internal and external environments of a moving platform 101. For example, the technology processes information relating to driving, such as data describing a driver's driving habits and familiarity with driving environments, models the processed information, and generates precise driving predictions based on the modeling. In some implementations, the modeling may be based on recognizing spatial and temporal patterns, as discussed further below.

Some implementations of the technology described in this disclosure include a customizable advance driver assistance engine 105 that may be configured to use and adapt a neural network based driver action prediction model. For example, the technology may generate training labels (also called targets) based on extracted feature(s) and detected driver action(s) and use the labels to incrementally update and improve the performance of a pre-trained driver action prediction model. For example, some implementations of the technology described herein improve the precision and recall of a neural network based driver action prediction model by detecting/recognizing an action in real time and using the labeled results of the recognition to update the driver action prediction model for the specific driver and/or circumstance.

As a further example, a driver action prediction model may include a computer learning algorithm, such as a neural network. For instance, some examples of neural network based driver action prediction models include one or more multi-layer neural networks, deep convolutional neural networks, and recurrent neural networks, although other machine learning models are also contemplated in this application and encompassed hereby.

As discussed briefly in the Background, computer learning models, such as neural networks, are data-driven solutions, and making accurate predictions often requires significant amounts of training data for the situations that system embodied by the computer learning model are likely to encounter. Accordingly, an impractically large training database is often required to cover every potential user in every potential situation. Some implementations of the technology described herein overcome this data collection barrier by providing a model adaptation engine 233 that may be configured to adapt a state of the art model (e.g., a stock machine learning-based driver action prediction model) using locally acquired data, also referred to herein as local data or local sensor data (e.g., user specific, location specific, moving platform 101 specific, etc., data). As such, the technology may incorporate real-time detection of user actions, provide learning that is robust against classification noise in large datasets, and update an existing (e.g., factory built) driver action prediction model using local data (e.g., driver specific data) to adapt and improve on the driver action prediction model as opposed to, in some implementations, having to routinely replace the model with an improved pre-trained model in order to keep it current.

With reference to the figures, reference numbers may be used to refer to components found in any of the figures, regardless whether those reference numbers are shown in the figure being described. Further, where a reference number includes a letter referring to one of multiple similar components (e.g., component 000a, 000b, and 000n), the reference number may be used without the letter to refer to one or all of the similar components.

While the implementations described herein are often related to driving a vehicle, the technology may be applied to other suitable areas, such as machine operation, train operation, locomotive operation, plane operation, forklift operation, watercraft operation, or operation of any other suitable platforms. Further, it should be understood that while a user 115 may be referred to as a “driver” in some implementations described in the disclosure, the use of the term “driver” should not be construed as limiting the scope of the techniques described in this disclosure.

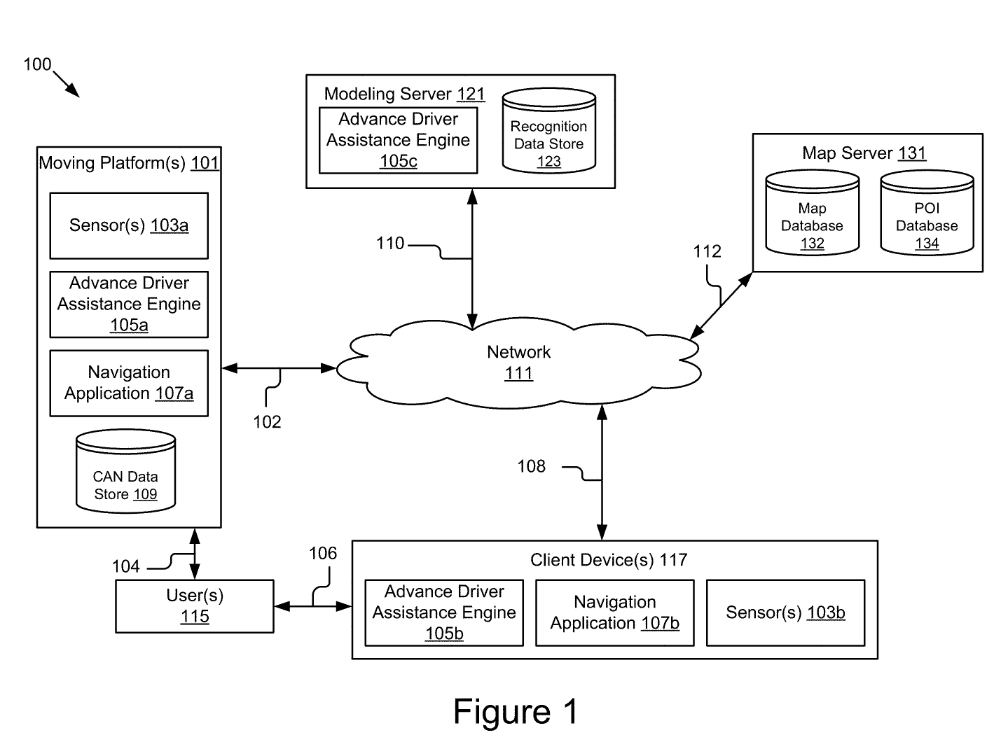

FIG. 1 is a block diagram of an example system 100. As illustrated, the system 100 may include a modeling server 121, a map server 131, client device(s) 117, and moving platform(s) 101. The entities of the system 100 may be communicatively coupled via a network 111. It should be understood that the system 100 depicted in FIG. 1 is provided by way of example and the system 100 and/or other systems contemplated by this disclosure may include additional and/or fewer components, may combine components, and/or divide one or more of the components into additional components, etc. For example, the system 100 may include any number of moving platforms 101, client devices 117, modeling servers 121, or map servers 131. For instance, additionally or alternatively, the system 100 may include a speech server for receiving and processing speech commands from a user 115, a search server for providing search results matching search queries, vehicle-to-vehicle (V2V) and vehicle-to-infrastructure (V2I) technologies, etc.

The network 111 may be a conventional type, wired and/or wireless, and may have numerous different configurations including a star configuration, token ring configuration, or other configurations. For instance, the network 111 may include one or more local area networks (LAN), wide area networks (WAN) (e.g., the Internet), public networks, private networks, virtual networks, mesh networks among multiple vehicles, peer-to-peer networks, and/or other interconnected data paths across which multiple devices may communicate.

The network 111 may also be coupled to or include portions of a telecommunications network for sending data in a variety of different communication protocols. In some implementations, the network 111 includes Bluetooth® communication networks or a cellular communications network for sending and receiving data including via short messaging service (SMS), multimedia messaging service (MMS), hypertext transfer protocol (HTTP), direct data connection, WAP, email, etc. In some implementations, the network 111 is a wireless network using a connection such as DSRC, WAVE, 802.11p, a 3G, 4G, 5G+ network, WiFi™, or any other wireless networks. In some implementations, the network 111 may include a V2V and/or V2I communication network(s) for communicating data among moving platforms 101 and/or infrastructure external to the moving platforms 101 (e.g., traffic or road systems, etc.). Although FIG. 1 illustrates a single block for the network 111 that couples the modeling server 121, the map server 131, the client device(s) 117, and the moving platform(s) 101, it should be understood that the network 111 may in practice comprise any number of combination of networks, as noted above.

The modeling server 121 may include a hardware and/or virtual server that includes processor(s), memory(ies), and network communication capabilities (e.g., communication unit(s)). The modeling server 121 may be communicatively coupled to the network 111, as reflected by signal line 110. In some implementations, the modeling server 121 may send and receive data to and from one or more of the map server 131, the client device(s) 117, and the moving platform(s) 101. In some implementations, the modeling server 121 may include an instance of the advance driver assistance engine 105c and a recognition data store 123, as discussed further elsewhere herein.

The recognition data store 123 may store terminology data for describing a user's actions, such as recognized labels generated by the advance driver assistance engine 105 or by some other method. In FIG. 1, the modeling server 121 is shown as including the recognition data store 123; however, it should be understood that the moving platform(s) 101 and/or the client device(s) 117 may additionally and/or alternatively store the recognition data store 123. For instance, the moving platform(s) 101 and/or the client device(s) 117 may include an instance of the recognition data store 123, may cache data from the recognition data store 123 (e.g., download the recognition data at various intervals), etc. For instance, in some implementations, some recognition data may be pre-stored/installed in the moving platform(s) 101, stored and/or refreshed upon setup or first use, replicated at various intervals, etc. In further implementations, data from the recognition data store 123 may be requested and downloaded at runtime or training. Other suitable variations are also possible and contemplated.

The client device(s) 117 are computing devices that include memory(ies), processor(s), and communication unit(s). The client device(s) 117 are coupleable to the network 111 and may send and receive data to and from one or more of the modeling server 121, the map server 131, and the moving platform(s) 101 (and/or any other components of the system coupled to the network 111). Non-limiting examples of client device(s) 117 include a laptop computer, a desktop computer, a tablet computer, a mobile telephone, a personal digital assistant (PDA), a mobile email device, a roadside sensor, a traffic light, a traffic camera, an embedded system, an appliance, or any other electronic devices capable of processing information and accessing a network 111. In some implementations, the client device(s) 117 may include one or more sensors 103b, a navigation application 107b, and/or an advance driver assistance engine 105b.

In some implementations, the client device(s) 117 may include an instance of a navigation application 107b, which may provide navigation instructions to user(s) 115, and/or GPS information to an advance driver assistance engine 105. The user(s) 115 may interact with the client device(s) 117, as illustrated by signal line 106. Although FIG. 1 illustrates one client device 117, the system 100 may include a plurality of client devices 117.

The moving platform(s) 101 include computing devices having memory(ies), processor(s), and communication unit(s). Examples of such computing devices may include an electronic control unit (ECU) or other suitable processor, which is coupled to other components of the moving platform(s) 101, such as one or more sensors 103a, actuators, motivators, etc. The moving platform(s) 101 may be coupled to the network 111 via signal line 102, and may send and receive data to and from one or more of the modeling server 121, the map server 131, and the client device(s) 117. In some implementations, the moving platform(s) 101 are capable of transporting people or objects from one location to another location. Non-limiting examples of the moving platform(s) 101 include a vehicle, an automobile, a bus, a boat, a plane, a bionic implant, or any other moving platforms with computer electronics (e.g., a processor, a memory or any combination of non-transitory computer electronics). The user(s) 115 may interact with the moving platform(s) 101, as reflected by signal line 104. The user(s) 115 may be a human user operating the moving platform(s) 101. For example, the user(s) 115 may be a driver of a vehicle.

The moving platform(s) 101 may include one or more sensors 103a, a Controlled Area Network (CAN) data store 109, an advance driver assistance engine 105a, and/or an instance of a navigation application 107a. Although FIG. 1 illustrates one moving platform 101, the system 100 may include a plurality of moving platforms 101, as may be encountered on a thoroughfare. For example, in some implementations, multiple moving platforms 101 may communicate with each other to share sensor data from the sensors 103.

The CAN data store 109 stores various types of vehicle operation data (also sometimes referred to as vehicle CAN data) being communicated between different components of a given moving platform 101 using the CAN, as described elsewhere herein. In some implementations, the vehicle operation data is collected from multiple sensors 103a coupled to different components of the moving platform(s) 101 for monitoring operating states of these components. Examples of the vehicle CAN data include, but are not limited to, transmission, speed, acceleration, deceleration, wheel speed (Revolutions Per Minute—RPM), wheel slip, traction control information, windshield wiper control information, steering angle, braking force, etc. In some implementations, the vehicle operation data may also include location data (e.g., GPS coordinates) describing a current location of the moving platform(s) 101. Other standard vehicle operation data are also contemplated. In some implementations, the CAN data store 109 may be part of a data storage system (e.g., a standard data or database management system) for storing and providing access to data.

The sensor(s) 103a and/or 103b (also referred to herein as 103) may include any type of sensors suitable for the moving platform(s) 101 and/or the client device(s) 117. The sensor(s) 103 may be configured to collect any type of sensor data suitable to determine characteristics of a moving platform 101, its internal and external environments, and/or a user's actions (e.g., either directly or indirectly). Non-limiting examples of the sensor(s) 103 include various optical sensors (CCD, CMOS, 2D, 3D, light detection and ranging (LIDAR), cameras, etc.), audio sensors, motion detection sensors, barometers, altimeters, thermocouples, moisture sensors, IR sensors, radar sensors, other photo sensors, gyroscopes, accelerometers, speedometers, steering sensors, braking sensors, switches, vehicle indicator sensors, windshield wiper sensors, geo-location sensors, transceivers, sonar sensors, ultrasonic sensors, touch sensors, proximity sensors, any of the sensors associated with the CAN data, as discussed above, etc.

The sensor(s) 103 may also include one or more optical sensors configured to record images including video images and still images of an inside or outside environment of a moving platform 101, record frames of a video stream using any applicable frame rate, encode and/or process the video and still images captured using any applicable methods, and/or capture images of surrounding environments within their sensing range. For instance, in the context of a moving platform 101, the sensor(s) 103a may capture the environment around the moving platform 101 including roads, roadside structure, buildings, trees, dynamic road objects (e.g., surrounding moving platforms 101, pedestrians, road workers, etc.) and/or static road objects (e.g., lanes, traffic signs, road markings, traffic cones, barricades, etc.), etc. In some implementations, the sensor(s) 103 may be mounted to sense in any direction (forward, rearward, sideward, upward, downward, facing etc.) relative to the path of a moving platform 101. In some implementations, one or more sensors 103 may be multidirectional (e.g., LIDAR).

The sensor(s) 103 may additionally and/or alternatively include one or more optical sensors configured to record images including video images and still images of a user's activity (e.g., whether facing toward the interior or exterior of the moving platform 101), record frames of a video stream using any applicable frame rate, and/or encode and/or process the video and still images captured using any applicable methods. For instance, in the context of a moving platform 101, the sensor(s) 103 may capture the user's operation of the moving platform 101 including moving forward, braking, turning left, turning right, changing to a left lane, changing to a right lane, making a U-turn, stopping, making an emergency stop, losing control on a slippery road, etc. In some implementations, the sensor(s) 103 may determine the operations of the moving platform 101 by capturing the user's steering action, braking activities, etc. In one or more implementations, the sensor(s) 103 may capture user's action and activities that are not directly related to the motions of the moving platform(s) 101, such as the user's facial expressions, head directions, hand locations, and other activities that might or might not affect the user's operations of the moving platform(s) 101. As a further example, the image data may reflect an aspect of a moving platform 101 and/or the user 115, such as a series of image frames monitoring a user's head motion for a period of time, etc.

The sensor(s) 103 may optionally include one or more signal receivers configured to record, transmit the vehicle information to other surrounding moving platforms 101, and receive information from the other surrounding moving platforms 101, client devices 117, sensors 103 on remote devices, etc. The information received from the other moving platforms 101 may be communicated to other components of the moving platform(s) 101 for further processing, such as to an advance driver assistance engine 105.

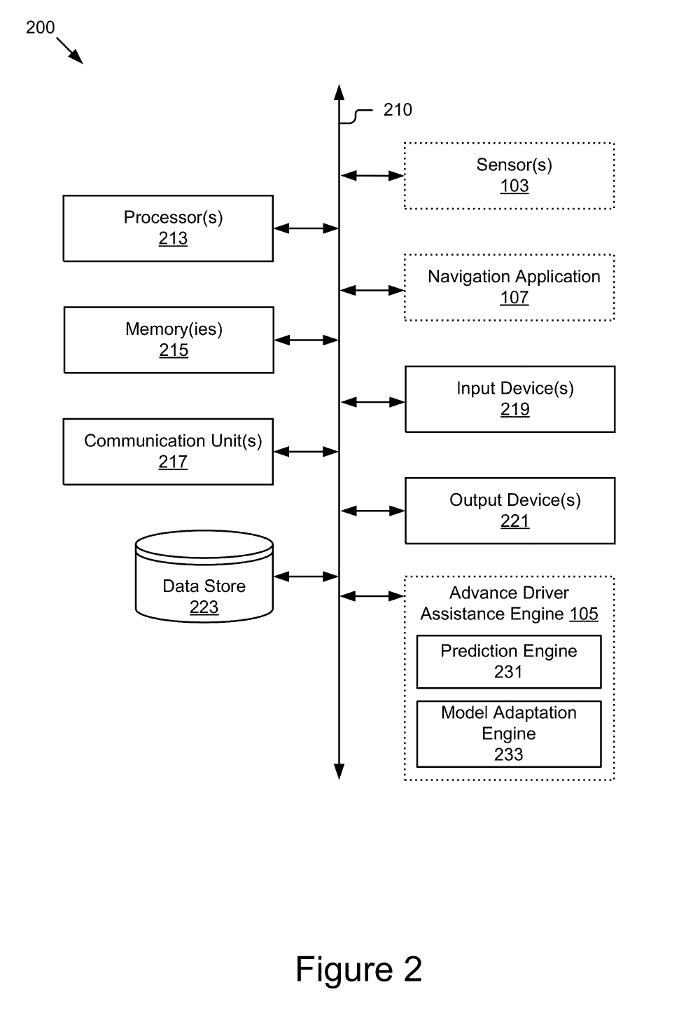

The processor(s) 213 (e.g., see FIG. 2) of the moving platform(s) 101, modeling server 121, and/or the client device(s) 117 may receive and process the sensor data from the sensors 103. In the context of a moving platform 101, the processor(s) 213 may include an electronic control unit (ECU) implemented in the moving platform 101 such as a vehicle, although other moving platform types are also contemplated. The ECU may receive and store the sensor data as vehicle operation data in the CAN data store 109 for access and/or retrieval by the advance driver assistance engine 105. In some instances, the vehicle operation data is directly provided to the advance driver assistance engine 105 (e.g., via the vehicle bus, via the ECU, etc., upon being received and/or processed). Other suitable variations are also possible and contemplated. As a further example, one or more sensors 103 may capture time-varying image data of the user 115 operating a moving platform 101, where the image data depict activities (such as looking left, looking right, moving the right foot from the gasoline pedal to the brake pedal, moving hands around the steering wheel) of the user 115 as the user 115 prepares for a next action while operating the moving platform 101. The advance driver assistance engine 105 may receive the sensor data (e.g., real-time video stream, a series of static images, etc.) from the sensor(s) 103 (e.g., via the bus, ECU, etc.) and process it to determine what action the user 115 will take in the future, as discussed further elsewhere herein.

The modeling server 121, the moving platform(s) 101, and/or the client device(s) 117 may include instances 105a, 105b, and 105c of the advance driver assistance engine 105. In some configurations, the advance driver assistance engine 105 may be distributed over the network 111 on disparate devices in disparate locations, in which case the client device(s) 117, the moving platform(s) 101, and/or the modeling server 121 may each include an instance of the advance driver assistance engine 105 or aspects of the advance driver assistance engine 105. For example, each instance of the advance driver assistance engine 105a, 105b, and 105c may comprise one or more of the sub-components depicted in FIG. 2, and/or different variations of these sub-components, which are discussed in further detail below. In some configurations, the advance driver assistance engine 105 may be an application comprising components 231 and 233 depicted in FIG. 2, for example.

The advance driver assistance engine 105 includes computer logic operable to receive or retrieve and process sensor data from the sensor(s) 103, recognize patterns of the sensor data, generate predicted future user actions and, in some implementations, adapt a driver action prediction model for a specific user 115, moving platform(s) 101, and/or environment. In some implementations, the advance driver assistance engine 105 may be implemented using software executable by one or more processors of one or more computer devices, using hardware, such as but not limited to a field-programmable gate array (FPGA), an application-specific integrated circuit (ASIC), etc., and/or a combination of hardware and software, etc. The advance driver assistance engine 105 is described below in more detail.

The navigation application 107 (e.g., one or more of the instances 107a or 107b) includes computer logic operable to provide navigation instructions to a user 115, display information, receive input, etc. In some implementations, the navigation application 107 may be implemented using software executable by one or more processors of one or more computer devices, using hardware, such as but not limited to a field-programmable gate array (FPGA), an application-specific integrated circuit (ASIC), etc., and/or a combination of hardware and software, etc.

The navigation application 107 may utilize data from the sensor(s) 103, such as a geo-location transceiver (e.g., GPS transceiver, cellular radio, wireless radio, etc.), configured to receive and provide location data (e.g., GPS, triangulation, cellular triangulation, etc.) for a corresponding computing device, sensors 103 (e.g., as sensor data), etc. For example, the moving platform(s) 101 and/or the client device(s) 117 may be equipped with such a geo-location transceiver and the corresponding instance of the navigation application 107 may be configured to receive and process location data from such a transceiver. The navigation application 107 is discussed in further detail below.

The map server 131 includes a hardware and/or virtual server having a processor, a memory, and network communication capabilities. In some implementations, the map server 131 receives and sends data to and from one or more of the modeling server 121, the moving platform(s) 101, and the client device(s) 117. For example, the map server 131 sends data describing a map of a geo-spatial area to one or more of the advance driver assistance engine 105 and the navigation application 107. The map server 131 is communicatively coupled to the network 111 via signal line 112. In some implementations, the map server 131 may include a map database 132 and a point of interest (POI) database 134.

The map database 132 stores data describing maps associated with one or more geographic regions, which may be linked with time and/or other sensor data and used/included as sensor data. In some implementations, map data may describe the one or more geographic regions at street level. For example, the map data may include information describing one or more lanes associated with a particular road. More specifically, the map data may describe the direction of travel of a road, the number of lanes on that road, exits and entrances to that road, whether one or more lanes have special status (e.g., are carpool lanes), the condition of the road in those lanes, traffic and/or accident data for those lanes, traffic controls associated with those lanes, (e.g., lane markings, pavement markings, traffic signals, traffic signs, etc.), etc. In some implementations, the map database 132 may include and/or be associated with a database management system (DBMS) for storing and providing access to data.

The point of interest (POI) database 134 stores data describing (POIs) for various geographic regions. For example, the POI database 134 stores data describing tourist attraction, hotels, restaurants, gas stations, university stadiums, landmarks, etc., along various road segments. In some implementations, the POI database 134 may include a database management system (DBMS) for storing and providing access to data.

It should be understood that the system 100 illustrated in FIG. 1 is representative of an example system and that a variety of different system environments and configurations are contemplated and are within the scope of the present disclosure. For instance, various acts and/or functionality may be moved from a modeling server 121, to a client device 117, to a moving platform 101, or otherwise, data may be consolidated into a single data store or further segmented into additional data stores, and some implementations may include additional or fewer computing devices, servers, and/or networks, and may implement various functionality client or server-side. Further, various entities of the system may be integrated into a single computing device or system or divided into additional computing devices or systems, etc.

FIG. 2 is a block diagram of an example computing device 200, which may represent the architecture of a modeling server 121, a client device 117, a moving platform 101, or a map server 131.

As depicted, the computing device 200 includes one or more processors 213, one or more memories 215, one or more communication units 217, one or more input devices 219, one or more output devices 221, and one or more data stores 223. The components of the computing device 200 are communicatively coupled by a bus 210. In some implementations where the computing device 200 represents the server 101, the client device(s) 117, or the moving platform(s) 101, the computing device 200 may include one or more advance driver assistance engines 105, one or more sensors 103, and/or one or more navigation applications 107, etc.

The computing device 200 depicted in FIG. 2 is provided by way of example and it should be understood that it may take other forms and include additional or fewer components without departing from the scope of the present disclosure. For example, while not shown, the computing device 200 may include various operating systems, software, hardware components, and other physical configurations.

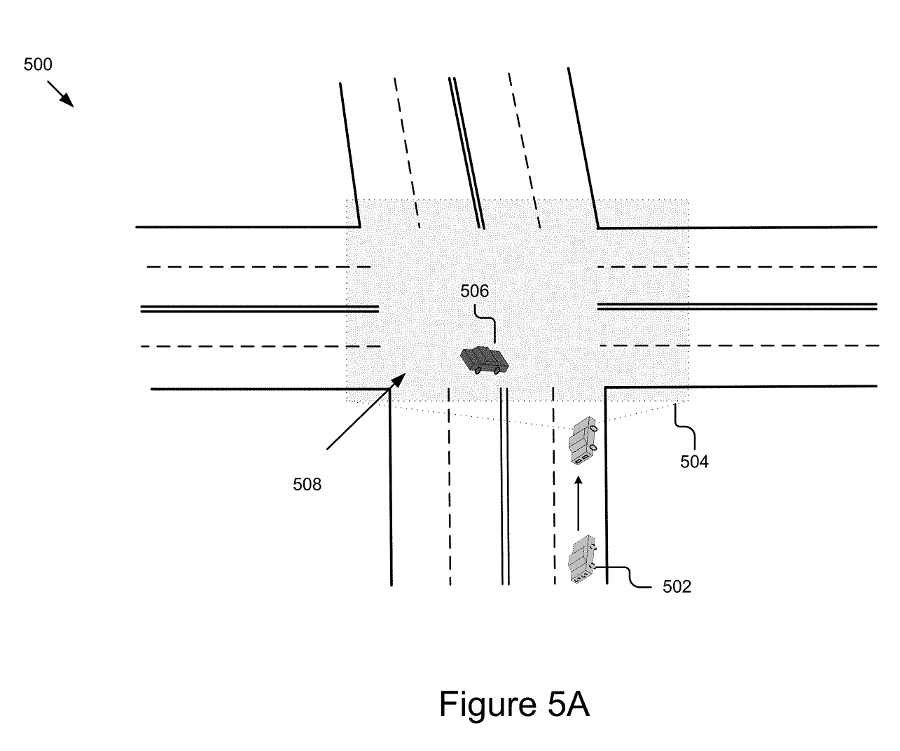

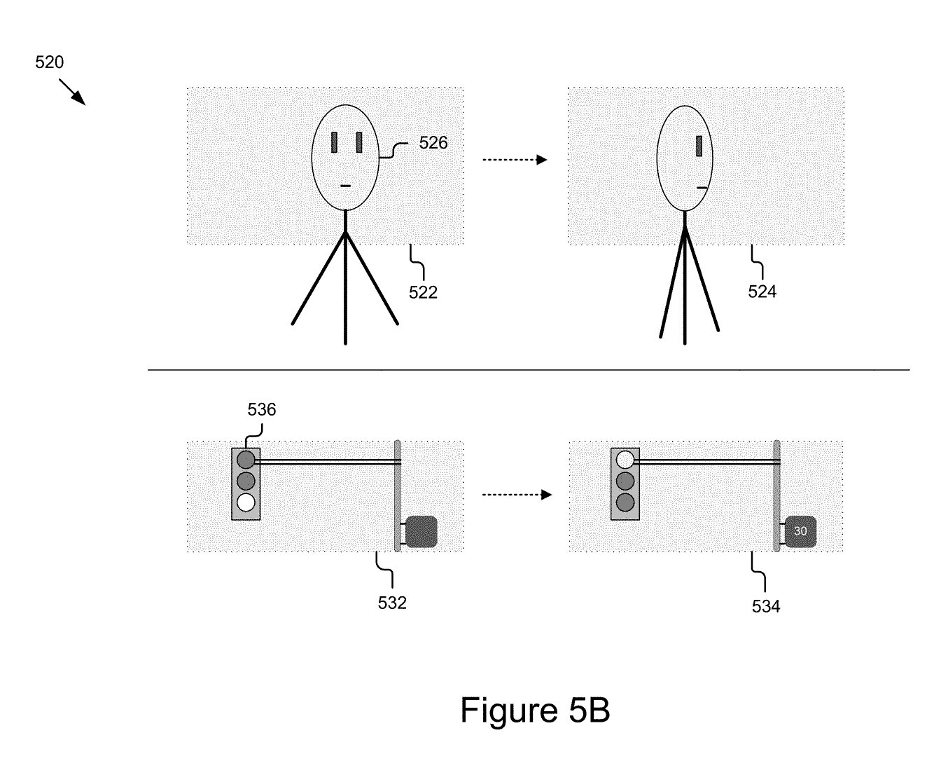

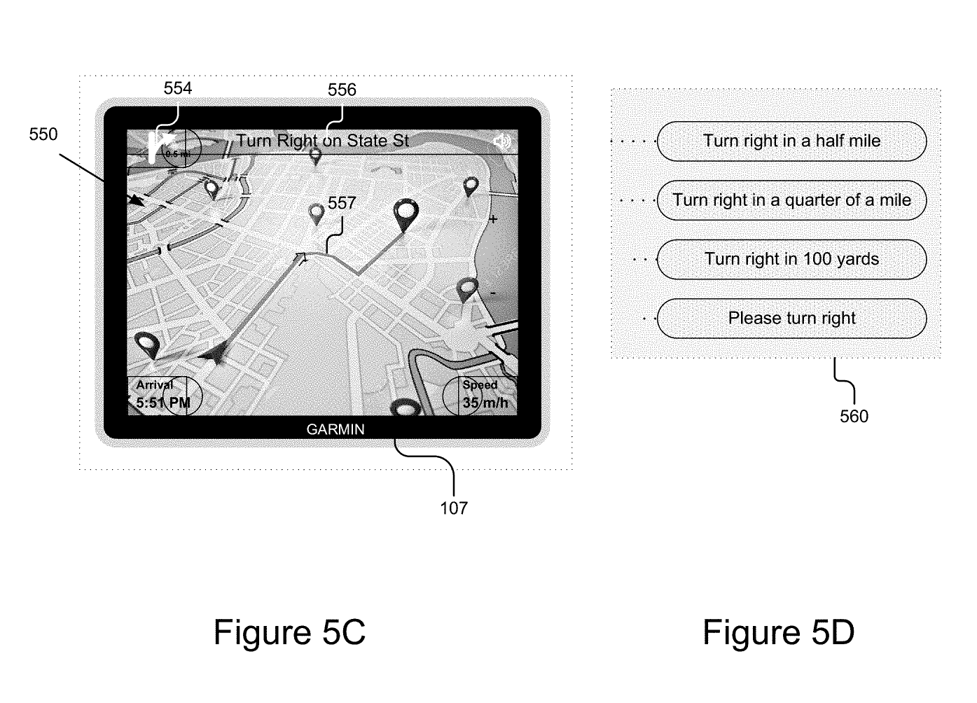

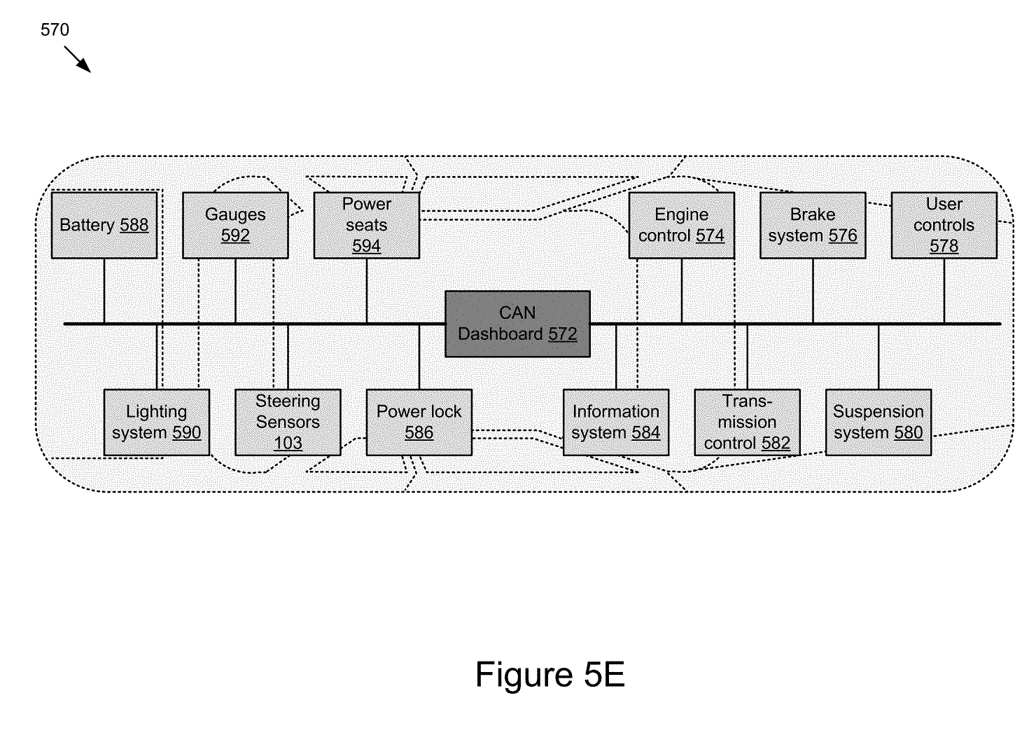

In some implementations where the computing device 200 is included or incorporated in moving platform(s) 101, the computing device 200 may include and/or be coupled to various platform components of the moving platform(s) 101, such as a platform bus (e.g., CAN, as described in reference to FIG. 5E), one or more sensors 103, such as, automotive sensors, acoustic sensors, video sensors, chemical sensors, biometric sensors, positional sensors (e.g., GPS, compass, accelerometer, gyroscope, etc.), switches, and controllers, cameras, etc., an internal combustion engine, electric motor, drivetrain parts, suspension components, instrumentation, climate control, and/or any other electrical, mechanical, structural, and mechanical components of the moving platform(s) 101. In these implementations, the computing device 200 may embody, be incorporated in, or include an ECU, ECM, PCM, etc. In further implementations, the computing device 200 may include an embedded system embedded in a moving platform 101.

The processor(s) 213 may execute software instructions by performing various input/output, logical, and/or mathematical operations. The processor(s) 213 may have various computing architectures to process data signals including, for example, a complex instruction set computer (CISC) architecture, a reduced instruction set computer (RISC) architecture, and/or an architecture implementing a combination of instruction sets. The processor(s) 213 may be physical and/or virtual, and may include a single core or plurality of processing units and/or cores. In some implementations, the processor(s) 213 may be capable of generating and providing electronic display signals to a display device (not shown), supporting the display of images, capturing and transmitting images, performing complex tasks including various types of feature extraction and sampling, etc. In some implementations, the processor(s) 213 may be coupled to the memory(ies) 215 via the bus 210 to access data and instructions therefrom and store data therein. The bus 210 may couple the processor(s) 213 to the other components of the computing device 200 including, for example, the memory(ies) 215, the communication unit(s) 217, the sensor(s) 103, the advance driver assistance engine 105, the navigation application 107, the input device(s) 219, the output device(s) 221, and/or and the data store 223.

The memory(ies) 215 may store and provide access to data to the other components of the computing device 200. In some implementations, the memory(ies) 215 may store instructions and/or data that may be executed by the processor(s) 213. For example, depending on the configuration of the computing device 200, the memory(ies) 215 may store one or more instances of the advance driver assistance engine 105 and/or one or more instances of the navigation application 107. The memory(ies) 215 are also capable of storing other instructions and data, including, for example, various data described elsewhere herein, an operating system, hardware drivers, other software applications, databases, etc. The memory(ies) 215 may be coupled to the bus 210 for communication with the processor(s) 213 and the other components of computing device 200.

The memory(ies) 215 include one or more non-transitory computer-usable (e.g., readable, writeable, etc.) media, which may be any tangible non-transitory apparatus or device that may contain, store, communicate, propagate or transport instructions, data, computer programs, software, code, routines, etc., for processing by or in connection with the processor(s) 213. In some implementations, the memory(ies) 215 may include one or more of volatile memory and non-volatile memory. For example, the memory(ies) 215 may include, but are not limited to, one or more of a dynamic random access memory (DRAM) device, a static random access memory (SRAM) device, a discrete memory device (e.g., a PROM, FPROM, ROM), a hard disk drive, an optical disk drive (CD, DVD, Blue-ray™, etc.). It should be understood that the memory(ies) 215 may be a single device or may include multiple types of devices and configurations.

The communication unit(s) 217 transmit data to and receive data from other computing devices to which they are communicatively coupled (e.g., via the network 111) using wireless and/or wired connections. The communication unit(s) 217 may include one or more wired interfaces and/or wireless transceivers for sending and receiving data. The communication unit(s) 217 may couple to the network 111 and communicate with other computing nodes, such as client device(s) 117, moving platform(s) 101, and/or server(s) 121 or 131, etc. (depending on the configuration). The communication unit(s) 217 may exchange data with other computing nodes using standard communication methods, such as those discussed above.

The bus 210 may include a communication bus for transferring data between components of a computing device 200 or between computing devices, a network bus system including the network 111 and/or portions thereof, a processor mesh, a combination thereof, etc. In some implementations, the bus 210 may represent one or more buses including an industry standard architecture (ISA) bus, a peripheral component interconnect (PCI) bus, a universal serial bus (USB), or some other bus known to provide similar functionality. Additionally and/or alternatively, the various components of the computing device 200 may cooperate and communicate via a software communication mechanism implemented in association with the bus 210. The software communication mechanism may include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The data store 223 includes non-transitory storage media that store data. A non-limiting example non-transitory storage medium may include a dynamic random access memory (DRAM) device, a static random access memory (SRAM) device, flash memory, a hard disk drive, a floppy disk drive, a disk-based memory device (e.g., CD, DVD, Blu-ray™, etc.), a flash memory device, or some other known, tangible, volatile or non-volatile storage devices. Depending on the computing device 200 represented by FIG. 2, the data store 223 may represent one or more of the CAN data store 109, the recognition data store 123, the POI database 134, and the map database 132, although other data store types are also possible and contemplated.

The data store 223 may be included in the one or more memories 215 of the computing device 200 or in another computing device and/or storage system distinct from but coupled to or accessible by the computing device 200. In some implementations, the data store 223 may store data in association with a DBMS operable by the modeling server 121, the map server 131, the moving platform(s) 101, and/or the client device(s) 117. For example, the DBMS could include a structured query language (SQL) DBMS, a NoSQL DMBS, etc. In some instances, the DBMS may store data in multi-dimensional tables comprised of rows and columns, and manipulate, e.g., insert, query, update and/or delete, rows of data using programmatic operations.

The input device(s) 219 may include any standard devices configured to receive a variety of control inputs (e.g., gestures, voice controls) from a user 115 or other devices. Non-limiting example input device 219 may include a touch screen (e.g., LED-based display) for inputting texting information, making selection, and interacting with the user 115; motion-detecting input devices; audio input devices; other touch-based input devices; keyboards; pointer devices; indicators; and/or any other inputting components for facilitating communication and/or interaction with the user 115 or the other devices. The input device(s) 219 may be coupled to the computing device 200 either directly or through intervening controllers to relay inputs/signals received from users 115 and/or sensor(s) 103.

The output device(s) 221 may include any standard devices configured to output or display information to a user 115 or other devices. Non-limiting example output device(s) 221 may include a touch screen (e.g., LED-based display) for displaying navigation information to the user 115, an audio reproduction device (e.g., speaker) for delivering sound information to the user 115, a display/monitor for presenting texting or graphical information to the user 115, etc. The outputting information may be text, graphic, tactile, audio, video, and other information that may be understood by the user 115 or the other devices, or may be data, logic, programming that can be readable by the operating system of the moving platform(s) 101 and/or other computing devices. The output device(s) 221 may be coupled to the computing device 200 either directly or through intervening controllers. In some implementations, a set of output device(s) 221 may be included in or form a control panel that a user may 115 interact with to adjust settings and/or control of a mobile platform 101 (e.g., driver controls, infotainment controls, guidance controls, safety controls, etc.).

In some implementations, the computing device 200 may include an advance driver assistance engine 105. The advance driver assistance engine 105 may include a prediction engine 231 and a model adaptation engine 233, for example. The advance driver assistance engine 105 and/or its components may be implemented as software, hardware, or a combination of the foregoing. In some implementations, the prediction engine 231 and the model adaptation engine 233 may be communicatively coupled by the bus 210 and/or the processor(s) 213 to one another and/or the other components of the computing device 200. In some implementations, one or more of the components 231 and 233 are sets of instructions executable by the processor(s) 213. In further implementations, one or more of the components 231 and 233 are storable in the memory(ies) 215 and are accessible and executable by the processor(s) 213. In any of the foregoing implementations, these components 231 and 233 may be adapted for cooperation and communication with the processor(s) 213 and other components of the computing device 200.

The prediction engine 231 may include computer logic operable to process sensor data to predict future actions, such as future driver actions relating to the mobile platform 101. In some implementations, the prediction engine 231 may extract features from sensor data for use in predicting the future actions of a user, for example, by inputting the extracted features into a driver action prediction model.

In some implementations, the prediction engine 231 may receive sensor data from sensors 103 relating to the mobile platform 101 environment, such as inside or outside of a vehicle, a driver's actions, other nearby mobile platforms 101 and/or infrastructure, etc. The prediction engine 231 may analyze the received sensor data and remove the noise and/or unnecessary information of the sensor data. In some implementations, sensor data received by the sensor(s) 103 may contain different features and/or formats. The prediction engine 231 may filter various features and/or normalize these different formats to be compatible with the driver action prediction model.

The prediction engine 231 may include computer logic operable to extract features from the sensor data. In some implementations, the prediction engine 231 may extract features that can be used independently to recognize and/or predict user actions. In some implementations, the prediction engine 231 may extract features from sensor data received directly from the sensors 103.

Although it is described that the model adaptation engine 233 may recognize driver actions, in some implementations, these action(s) are performed by the prediction engine 231. For example, the prediction engine 231 may also or alternatively include computer logic operable to recognize actions based on sensor data and/or features. In some implementations, the prediction engine 231 may include an algorithmic model component that recognizes or detects user actions from extracted features or sensor data. For example, the prediction engine 231 may generate labels (e.g., using a computer learning model, a hand labeling coupled to a classifier, etc.) describing user actions based on the sensor data.

The prediction engine 231 may include computer logic operable to predict actions based on sensor data and/or features. In some implementations, the prediction engine 231 runs a driver action prediction model (e.g., as described in further detail elsewhere herein) on the extracted features in order to predict user actions. For example, in some instances, the prediction engine 231 may continuously predict future driver action by running a driver action prediction model on the features extracted for prediction as the features are received (e.g., in real-time, near real-time, etc.).

The prediction engine 231 may be adapted for cooperation and communication with the processor(s) 213, the memory(ies) 215, and/or other components of the computing device 200 via the bus 210. In some implementations, the prediction engine 231 may store data, such as extracted features in a data store 223 and/or transmit the features to one or more of the other components of the advance driver assistance engine 105. For example, the prediction engine 231 may be coupled to the model adaptation engine 233 to output features and/or predicted driver actions, labels, or targets, for example, to allow the model adaptation engine 233 to update the driver action prediction model.

The model adaptation engine 233 may include computer logic operable to recognize driver actions, generate training examples, and/or update a driver action prediction model based on local data. In some implementations, local data my include sensor data, extracted features, and driver action predictions for a user 115, and/or the circumstances in which the user is active relating to the moving platform 101, other moving platforms 101, or other similar circumstances.

In some implementations, the model adaptation engine 233 be configured to recognize driver actions, for example, based on sensor data. For example, the model adaptation engine 233 may include computer logic operable to recognize actions based on sensor data and/or features. In some implementations, the model adaptation engine 233 may include an algorithmic model component that recognizes or detects user actions from extracted features or sensor data. For example, the model adaptation engine 233 may generate labels (e.g., using a computer learning model, a hand labeling coupled to a classifier, etc.) describing user actions based on the sensor data.

In some implementations, the model adaptation engine 233 may include computer logic operable to train the driver action prediction model and/or the weights thereof, for example. In some implementations, the model adaptation engine 233 may run a training algorithm to generate training examples (e.g., by combining features extracted for prediction and a recognized action label), which are then used to update train the driver action prediction model, as described in further detail elsewhere herein.

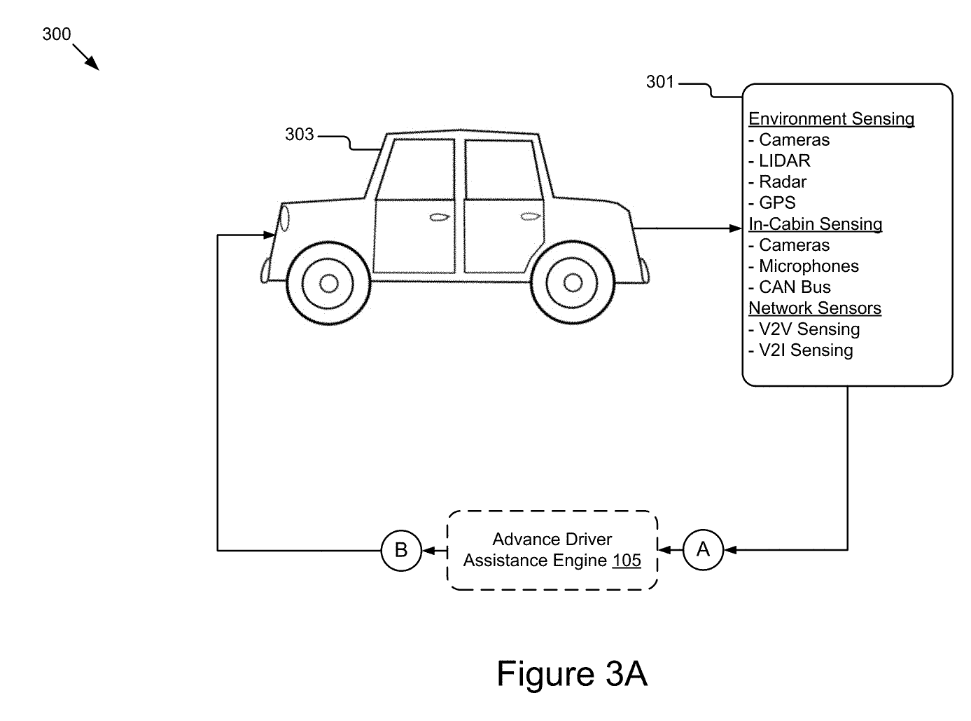

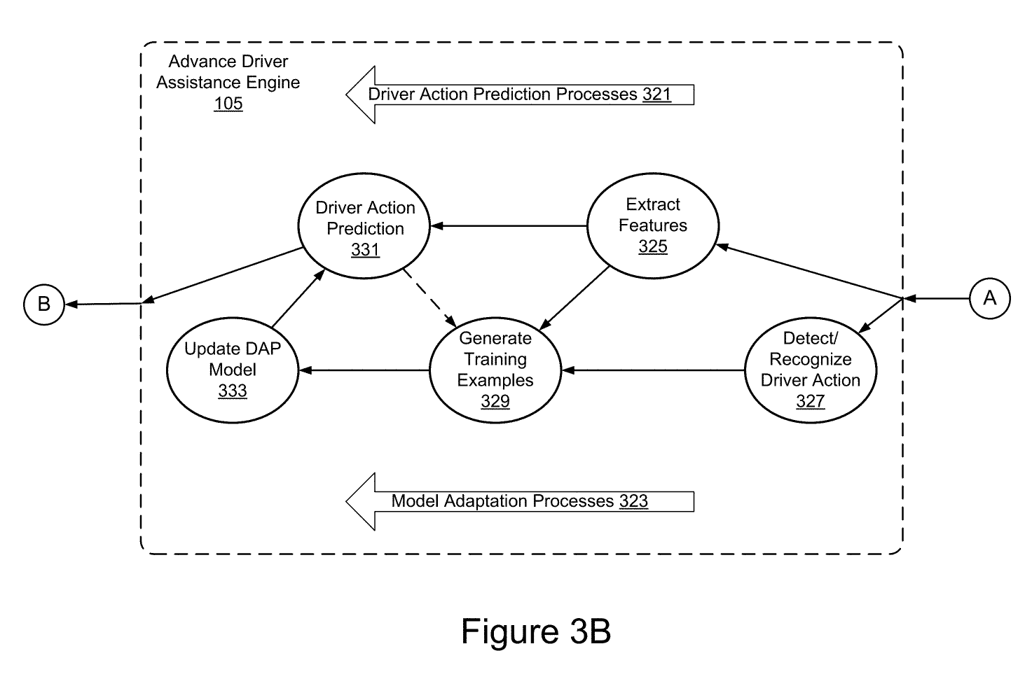

FIG. 3A is a block diagram of an example deployment 300 of the advance driver assistance engine 105. The improved precision and recall using the adaptable advance driver assistance engine 105 may be provided by running processes including detecting/recognizing driver action over time using labeled results (of driver actions) to update the driver action prediction model for a specific user. The examples illustrated in FIGS. 3A and 3B illustrate that at least some of the processes, according to some implementations of the techniques described herein, can run in parallel, thereby labeling incoming data and using it to improve models, for instance, while the user is driving, upon conclusion of driving (parked, parking), in advance of a predicted future trip, etc.

The advance driver assistance engine 105 self-customizes based in part on the driver monitoring capabilities of the moving platforms 101. In the context of an automobile, the monitoring capabilities include, but are not limited to brake and gas pedal pressures, steering wheel angles, GPS location histories, eye-tracking, cameras facing the driver, as well as any other sensor data described herein, although it should be understood that in other contexts (e.g., airplanes, ships, trains, other operator-influenced platforms, other sensor data reflect operating behavior is also possible and contemplated.

This wealth of sensor data about the driver, moving platform 101, and environment of the driver/moving platform 101 may be used by the advance driver assistance engine 105 to allow driver actions to be recognized in real-time, and/or be synchronized with further sensor data, e.g., from on-vehicle sensors 103 that sense the external environment (e.g. cameras, LIDAR, Radar, etc.), network sensors (via V2V, V2I interfaces sensing communication from other nodes of the network 111), etc. A multiplicity of sensor data may be used by the advance driver assistance engine 106 to perform real-time training data collection for training the driver action prediction model for a specific driver, so that the driver action prediction model can be adapted or customized to predict that specific driver's actions.

As a further example, the diagram 300 illustrates that the advance driver assistance engine 105 may receive sensor data 301 from sensors 103 (not shown) associated with a moving platform 101, such as the vehicle 303. The sensor data 301 may include environment sensing data, in-cabin sensing data, network sensor data, etc. For example, environment sensing data may include cameras (e.g., externally facing), LIDAR, Radar, GPS, etc.; in-cabin sensing data may include cameras (e.g., internally facing), microphones, CAN bus data (e.g., as described elsewhere herein), etc.; and the network sensor data, V2V sensing (e.g., sensor data provided from one vehicle to another vehicle), V2I sensing (e.g., sensor data provided by infrastructure, such as roads or traffic sensors, etc.), etc.

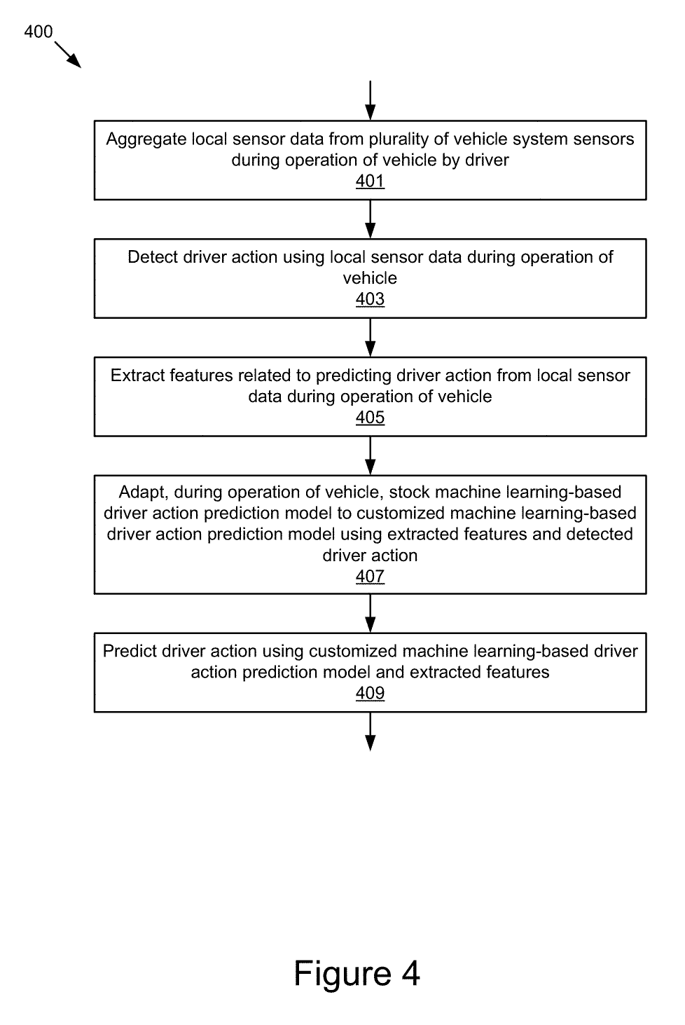

Using the sensor data 301, the advance driver assistance engine 105 then predict driver actions and/or adapt a driver action prediction model, as described in further detail elsewhere herein, for example, in reference to FIGS. 3B and 4. In some implementations, the predicted future driver action may be returned to other systems of the vehicle 303 to provide actions (e.g., automatic steering, braking, signaling, etc.) or warnings (e.g., alarms for the driver), may be transmitted to adjacent vehicles and/or infrastructure to notify these nodes of impending predicted driver actions, and which may be processed by the predictive systems of those vehicles (e.g. instances of the advance driver assistance engine 105) and/or infrastructure to take counter actions (e.g., control the steering of those systems to swerve or make a turn, change a street light, route vehicles along other paths, provide visual, tactile, and/or audio notifications, etc.).

FIG. 3B is a block diagram of an example implementation for updating a model using the advance driver assistance engine 105. The block diagram illustrates a process for customizing a driver action prediction model (e.g., a neural network based machine learning algorithm) using local data collected for a specific vehicle 303 and/or driver, which adaptation may be performed in parallel with driver action prediction.

As depicted in FIG. 3B, in some implementations, the advance driver assistance engine 105 includes driver action prediction processes 321 and model adaptation processes 323. In some instances, the driver action prediction processes 321, which may be performed by the prediction engine 231, may include extracting features at 325 and driver action prediction at 327. In some instances, the model adaptation processes 323, which may be performed by the model adaptation engine 233, may include detecting (e.g., discovering and recognizing) driver actions at 327, generating training examples at 329, and updating a driver action prediction model at 333.

In the example depicted in FIG. 3B, the advance driver assistance engine 105 may receive or retrieve the stored sensor data (e.g., sensor data cached or stored in memory) and, at 325, extract features from the sensor data. At 331, the advance driver assistance engine 105 may predict one or more driver actions using the driver action prediction model, for example, if no adaptation has occurred, the driver action prediction model may include a stock machine learning-based driver action prediction model. Stock means the model was pre-trained using a collective of sensor data aggregated from a multiplicity of moving platforms 101 to identify general driver behavior. In some instances, the stock model may be trained at a vendor's facility (a factory) before being sold or provided to a driver.

At 327, the advance driver assistance engine 105 may detect/recognize driver action. Driving a vehicle 303 is a special case of human-machine interaction where the user's actions can be observed because the user is highly involved with the machine. The sensor data reflecting the driver's and mobile platform's characteristics can precisely and accurate reflect what the user is doing and when the user is performing these actions. As described in greater detail elsewhere herein, methods for recognizing driver action may include applying thresholds to sensing, logistic regression, support vector machine, shallow multi-layer perception, convolutional neural network, etc. These recognition models may take any sensor data related to a driver action of interest, whether from sensors 103 on a moving platform 101/vehicle 303 or from remote sensors 103. For instance, driver actions of interest can be recognized by placing sensors in or out of the vehicle 303. For example, sensor data can be acquired via V2V or V2I communications. Regardless of the method by which the sensor data is acquired, the advance driver assistance engine 105 may detect, in some instances in real-time, the underlying user action.

At 329, the advance driver assistance engine 105 may generate training examples using the features extracted for prediction and the recognized driver actions. In some implementations, when an action is detected (e.g., at 327), the recognized action (e.g., a label of the action) may be passed to the next node to be used along with extracted features to train examples. For example, the advance driver assistance engine 105 may synchronize the labeled action from the recognized driver action with feature vectors (e.g., features, actions, data, etc. may be represented as vectors) accumulated over a given period (e.g., over the previous N seconds, where N is the appropriate duration for training driver action prediction).

The advance driver assistance engine 105 may also determine whether or not the labeled action is useful for updating the model and make the labeled data available for updating the driver action prediction model. The determination whether or not to add new data for training may address overfitting. For example, if a driver action prediction model is trained on data mostly involving only a single kind of driving (e.g., a daily commute), then the driver action prediction model may generate precise, accurate (e.g., within an acceptable level of confidence (e.g., 90%, 95%, 99.9%, etc.)) predictions during that kind of driving, but will be less reliable in other driving scenarios (e.g., long distance travel). Accordingly, depending on an administrative or user setting, for example, the advance driver assistance engine 105 may be configured to discard some data points, such as those that are already well represented by a previous iteration and/or already covered by the driver action prediction model. It should, however, be understood that other potential strategies for optimizing learning are possible and contemplated herein, such as using all data points, using various subsets of data points, etc.

At 333, the advance driver assistance engine 105 may update (also called train) the driver action prediction network model with local data (e.g., driver, vehicle, or environment specific data), as described elsewhere herein. In some implementations, a non-individualized driver action prediction model may be loaded into the advance driver assistance engine 105 initially and then the model may be adapted to a specific user, vehicle 303, or environment, etc. For example, one of the advantages of the technology described herein is that it allows pre-existing models to be adapted, so that the advance driver assistance engine 105 will work with a stock, pre-trained model and also be adapted and improved upon (e.g., rather than being replaced outright).

The decision process for updating the driver action prediction model can be simple or complex, depending on the implementation. Some examples include: updating the driver action prediction model using some or all labeled data points (e.g., the extracted features and/or the detected driver actions, as described above), and/or data points within certain classifications; comparing live driver action prediction model results with actual labeled data (e.g., as represented by the dashed line); or estimating the utility of a new database based in its uniqueness in the existing dataset and discarding a threshold amount of the labeled data that has a low uniqueness value, etc.

The labeled data (e.g., the output of the driver action recognition at 327, described above) may be useful for training an adapted (improved, updated, etc.) driver action prediction model. In some implementations, training neural networks may be performed using backpropagation that implements a gradient descent approach to learning. In some instances, the same algorithm may be used for processing a large dataset as is used for incrementally updating the model. Accordingly, instead of retraining the method from scratch when new data is received, the model can be updated incrementally as data is iteratively received (e.g., in batches, etc.), and/or may be updated based on sensor data type or types to more accurately train certain types of outcomes, etc.

FIG. 4 is a flowchart of an example method 400 for individually adapting driver action prediction models. The method 400 includes additional details and examples to those described above for using an advance driver assistance engine 105, according to the techniques of this disclosure, to predict driver actions and adapt a driver action prediction model using local data.

At 401, the advance driver assistance engine 105 may aggregate local sensor data from a plurality of vehicle system sensors 103 during operation of vehicle (e.g., a moving platform 101) by a driver. In some implementations, aggregating the local sensor data may include receiving localized data from one or more other adjacent vehicles reflecting local conditions of a surrounding environment surrounding the vehicle. For example, the localized data may include sensor data about the driver's actions, vehicle, environment, etc., received from the vehicle itself, from other vehicles via V2V communication, from other vehicles, or infrastructure via V2I communication, etc.

At 403, the advance driver assistance engine 105 may detect a driver action using the local sensor data during the operation of the vehicle. Detecting a driver action may include recognizing one or more driver actions based on sensor data and, in some instances, using the local sensor data to label the driver action. According to the technology described herein, there are multiple potential methods for recognizing the driver's actions after they have occurred, for example, applying thresholds to sensing, using logistic regression, a support vector machine, shallow multi-layer perception, a convolutional neural network, etc.

For instance, some examples implementations for recognizing a driver's action may include recognizing braking actions by filtering and quantizing brake pressure data; recognizing acceleration actions from gas pedal pressure data; and recognizing merge and turn data using logistic regression on a combination of turn signal, steering angle, and road curvature data.

In some implementations, the input into the model for recognizing actions may include any sensor data directly related to the action of interest of the driver. For example, the local sensor data may include one or more of: internal sensor data from sensors located inside a cabin of the vehicle; external sensor data from sensors located outside of the cabin of the vehicle; network-communicated sensor data from one or more of adjacent vehicles and roadway infrastructure equipment; braking data describing braking actions by the driver; steering data describing steering actions by the driver; turn indicator data describing turning actions by the driver; acceleration data describing acceleration actions by the driver; control panel data describing control panel actions by the driver; vehicle-to-vehicle data; and vehicle-to-infrastructure data. It should be noted that other types of local sensor data are possible and contemplated and that, as described above, local sensor data can originate from other vehicles or infrastructure (e.g., via V2V or V2I communication).

At 405, the advance driver assistance engine 105 may extract features related to predicting driver action from the local sensor data during operation of the vehicle. In some implementations, extracting the features related to predicting driver action from the local sensor data includes generating one or more extracted features vectors including the extracted features. For example, sensor data may be processed to extract features related to predicting actions (e.g., positions and speeds of other vehicles in the surrounding environment is useful for estimating the likelihood of the driver stepping on the brake pedal) and those features may be synchronized and collected in a vector that is passed to a driver action prediction model (e.g., a neural network based driver action prediction model may include one or more multi-layer neural networks, deep convolutional neural networks, and recurrent neural networks). In some instances, the advance driver assistance engine 105 may determine a driver action prediction duration, wherein the features are extracted from the local sensor data over the driver action prediction duration.

At 407, the advance driver assistance engine 105 may adapt (in some instances, during operation of the vehicle) a stock machine learning-based driver action prediction model to a customized machine learning-based driver action prediction model using one or more of the extracted features and the detected driver action. For example, the stock machine learning-based driver action prediction model may be initially generated using a generic model configured to be applicable to a generalized driving populace.

In some implementations, adapting the stock machine learning-based driver action prediction model includes training the stock machine learning-based driver action prediction model using the localized data. For example, training the stock machine learning-based driver action prediction model may include iteratively updating the stock machine learning-based driver action prediction model using sets of newly received local sensor data.

In some implementations, adapting the stock machine learning-based driver action model to a customized machine learning-based driver action prediction model using one or more of the extracted features and the detected driver action may include generating training examples and updating the model using the generated training examples.

In some implementations, generating training examples may include synchronizing the labeled driver action with the one or more extracted feature vectors. For example, synchronizing the labeled driver action with the one or more features may include labeling the features of the one or more extracted feature vectors and determining which of the extracted features from the one or more extracted feature vectors to use in adapting the machine learning-based driver action prediction model. Additional details regarding synchronizing the labeled action with the extracted features are described elsewhere herein.

In some implementations, updating the stock machine learning-based driver action model may include training or re-training the driver action prediction model using the same method that was used to originally train the model. For example, updating an already existing/already trained model (e.g., the stock machine learning-based driver action model) allows an advance driver assistance engine 105 to be loaded initially with a generic, non-individualized driver action prediction model that may have been trained with a large, multi-driver training set. For instance, once a new driver has taken possession of the vehicle, local sensor data about that driver's action may be recognized and used to update the existing, previously trained model. Accordingly, the complexity of the model may be preserved by learning from a generalized, broadly-applicable (to many driver types) dataset, but the model is adapted to perform especially well for a particular driver and/or set of driving conditions (e.g., the geographic area, driving characteristics, etc., where the driver typically operates the vehicle).

In some implementations, a driver action prediction model may be updated for a particular set of conditions or for a particular driver. For example, onboard driver action prediction models could be updated from actions observed in other vehicles. For instance, if a driver, John Doe, has two cars, then John's customized driver action prediction model may be shared between the cars (e.g., even though the second car does not directly sense John's actions in the first car). In some implementations, the customized driver action prediction models, as discussed above, may be linked to John (e.g., to a profile, etc.), so that the cars can share John's data (e.g., via local V2V communications, connecting to a central server, etc.).

Continuing the example from above, the driver action prediction model can be adapted based on other conditions than the specific driver. For example, if John Doe were to move to a new city then, although the model has become very good at predicting John's behavior around his old city, the model may have limited or no information specific to his new city. Accordingly, in some implementations, the advance driver assistance engine 105 may communicate with a central database (e.g., of a vehicle manufacturer), so that new training examples of driver action prediction at the new city can be downloaded to the advance driver assistance engine 105 on John's vehicle and used to update the local driver action prediction model without completely replacing or removing the training specific to John.

At 409, the advance driver assistance engine 105 may predict a driver action using the customized machine learning-based driver action prediction model and the extracted features (whether the extracted features discussed above, or another set of extracted features at a later time). For example, extracted features may include a current set of features (e.g., the current set of features may describe the vehicle in motion at a present time) from current sensor data, which features may be fed into the customized machine learning-based driver action prediction model.

FIGS. 5A-5E illustrate various different examples of sensor data. FIG. 5A in particular depicts a diagram 500 example image data that may be captured and provided by external sensor(s) of a moving platform 101. The image data illustrated in the figure include aspect(s) of the environment outside the moving platform 101. In the illustrated example, the moving platform 101, a vehicle 502, is moving north in a four-lane road with two lanes for traffic in each direction. Sensor(s) 103, for instance, front facing image sensor(s), may be installed in the vehicle 502 to monitor the road condition in front of the vehicle 502. Image data, represented by the grey box 504, may be captured at the moment when the vehicle 502 is approaching the intersection 508. The image data contains road traffic data in front the vehicle 502 at that moment, such as a series of frames depicting another vehicle 506 located in the intersection and moving eastward.

FIG. 5B depicts a diagram 520 of further examples of time-varying image data that may monitor the environments inside and/or outside of a moving platform 101. The image data may include a series of images taken at different times. For instance, the images indicated by the grey boxes 522 and 524 respectively represent two images taken sequentially at different times to monitor a driver's head 526 motions inside a vehicle. The difference between the images 522 and 524 indicates that the driver is turning his/her head left. For another example, grey boxes 532 and 534 respectively represent two images taken sequentially at different times to monitor traffic control signal outside a vehicle. The difference between the images 532 and 534 indicates that the traffic light signal 536 has just changed from green (as shown in the image 532) to red (as shown in the image 534).

FIG. 5C depicts example sensor data, which includes navigation data that may be received from a location device, such as a GPS or other suitable geolocation unit, by the sensor data processor 232. In some implementations, the navigation application 107 may be operable by the location device to provide navigation instructions to a driver, although other variations of the navigation application 107 are also possible and contemplated, as discussed elsewhere herein.

As illustrated in the grey box 552 of FIG. 5C, the navigation data may include information regarding previous, current, and future locations of a moving platform 101. For instance, the navigation data may include information regarding current status of the moving platform 101, such as speed, direction, current road, etc. The navigation data may also include future positions of the moving platform 101 based on a mapped navigation path, intended destination, turn-by-turn instructions, etc. as 554, 556, 557, and 560 show. The navigation data may additionally or alternatively include map data, audio data, and other data as discussed elsewhere herein. FIG. 5D depicts example turn-by-turn instructions for a user 101, which may be related to a route displayed to the user. The instructions may be output visually and/or audibly to the user 115 via one or more output devices 221 (e.g., a speaker, a screen, etc.).

In some implementations, audio data received by the sensor data may include any sound signals captured inside and/or outside the moving platform 101. Non-limiting examples of audio data include a collision sound, a sound emitted by emergency vehicles, an audio command, etc. In some implementations, sensor data may include time-varying directions for the driver of a vehicle.

FIG. 5E depicts an example CAN network 870 from which CAN data may be extracted. The CAN network 570 may comprise one or more sensor sources. For instance, the CAN network 570, and/or non-transitory memory that stores data captured by it, may comprise a collective sensor source, or each of the constituent sets of sensors 103 (e.g., 574, 576, 578, etc.) included in the network 570 may each comprise sensor sources.

The CAN network 570 may use a message-based protocol that allows microcontrollers and devices to communicate with each other without a host computer. The CAN network 570 may convert signals to data that may be stored and transmitted to the sensor data processor 232, an ECU, a non-transitory memory, and/or other system 100 components. Sensor data may come from any of the microcontrollers and devices of a vehicle, such as user controls 578, the brake system 576, the engine control 574, the power seats 594, the gauges 592, the batter(ies) 588, the lighting system 590, the steering and/or wheel sensors 103, the power locks 586, the information system 584 (e.g., audio system, video system, navigational system, etc.), the transmission control 582, the suspension system 580, etc.

In addition or alternatively to the example sensor data discussed with reference to FIGS. 5A-E, it should be understood that numerous other types of sensor data may also be used, such as electronic message data, other sensor data, data from other moving platforms 101, data from predefined systems, etc. For instance, sensor data received by a vehicle may include an electronic message data received from another incoming vehicle from the opposite direction, informing a planned/anticipated left turn in seconds.

In the above description, for purposes of explanation, numerous specific details are set forth in order to provide a thorough understanding of the present disclosure. However, it should be understood that the technology described herein could be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that may receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein may take the form of an entirely hardware implementation, an entirely software implementation, or implementations containing both hardware and software elements. For instance, the technology may be implemented in software, which includes but is not limited to firmware, resident software, microcode, etc. Furthermore, the technology may take the form of a computer program product accessible from a computer-usable or computer-readable medium providing program code for use by or in connection with a computer or any instruction execution system. For the purposes of this description, a computer-usable or computer readable medium may be any non-transitory storage apparatus that may contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements may include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, processors, routines, features, attributes, methodologies and other aspects are not mandatory or significant, and the mechanisms that implement the specification or its features may have different names, divisions and/or formats.

Furthermore, the modules, processors, routines, features, attributes, methodologies and other aspects of the disclosure may be implemented as software, hardware, firmware, or any combination of the foregoing. Also, wherever a component, an example of which is a module, of the specification is implemented as software, the component may be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A computer-implemented method, the method comprising:
aggregating local sensor data from a plurality of vehicle system sensors during operation of vehicle by a driver;
detecting, during the operation of the vehicle, a driver action using the local sensor data;
extracting, during the operation of the vehicle, features related to predicting driver action from the local sensor data;
adapting, during operation of the vehicle, a stock machine learning-based driver action prediction model to a customized machine learning-based driver action prediction model using one or more of the extracted features and the detected driver action, the stock machine learning-based driver action prediction model initially generated using a generic model configured to be applicable to a generalized driving populace; and
predicting a driver action using the customized machine learning-based driver action prediction model and the extracted features.

2. The computer-implemented method of claim 1, wherein
detecting the driver action using the local sensor data includes labeling the driver action,
extracting the features related to predicting driver action from the local sensor data includes generating one or more extracted features vectors including the extracted features, and
the method of further includes synchronizing the labeled driver action with the one or more extracted features vectors.

3. The computer-implemented method of claim 2, further comprising:
determining a driver action prediction duration, wherein the features are extracted from the local sensor data over the driver action prediction duration.

4. The computer-implemented method of claim 2, wherein synchronizing the labeled driver action with the one or more extracted feature vectors includes labeling the features of the one or more extracted feature vectors and determining which of the extracted features from the one or more extracted feature vectors to use in adapting the machine learning-based driver action prediction model.

5. The computer-implemented method of claim 1, wherein the local sensor data includes one or more of internal sensor data from sensors located inside a cabin of the vehicle, external sensor data from sensors located outside of the cabin of the vehicle, and network-communicated sensor data from one or more of adjacent vehicles and roadway infrastructure equipment.

6. The computer-implemented method of claim 1, wherein the local sensor data includes one or more of braking data describing braking actions by the driver, steering data describing steering actions by the driver, turn indicator data describing turning actions by the driver, acceleration data describing acceleration actions by the driver, control panel data describing control panel actions by the driver, vehicle-to-vehicle data, and vehicle-to-infrastructure data.

7. The computer-implemented method of claim 1, wherein adapting the stock machine learning-based driver action prediction model includes iteratively updating the stock machine learning-based driver action prediction model using sets of newly received local sensor data.

8. The computer-implemented method of claim 1, wherein
aggregating the local sensor data includes receiving localized data from one or more other adjacent vehicles reflecting local conditions of a surrounding environment surrounding the vehicle, and
adapting the stock machine learning-based driver action prediction model includes training the stock machine learning-based driver action prediction model using the localized data.

9. A computing system comprising:
one or more computer processors; and
one or more non-transitory memories storing instructions that, when executed by the one or more computer processors, cause the computer system to perform operations comprising:
aggregating local sensor data from a plurality of vehicle system sensors during operation of vehicle by a driver;
detecting, during the operation of the vehicle, a driver action using the local sensor data;
extracting, during the operation of the vehicle, features related to predicting driver action from the local sensor data;
adapting, during operation of the vehicle, a stock machine learning-based driver action prediction model to a customized machine learning-based driver action prediction model using one or more of the extracted features and the detected driver action, the stock machine learning-based driver action prediction model initially generated using a generic model configured to be applicable to a generalized driving populace; and
predicting a driver action using the customized machine learning-based driver action prediction model and the extracted features.

10. The computing system of claim 9, wherein
detecting the driver action using the local sensor data includes labeling the driver action,
extracting the features related to predicting driver action from the local sensor data includes generating one or more extracted features vectors including the extracted features, and
the method of further includes synchronizing the labeled driver action with the one or more extracted features vectors.

11. The computing system of claim 10, wherein the operations further comprise:
determining a driver action prediction duration, wherein the features are extracted from the local sensor data over the driver action prediction duration.

12. The computing system of claim 10, wherein synchronizing the labeled driver action with the one or more extracted feature vectors includes labeling the features of the one or more extracted feature vectors and determining which of the extracted features from the one or more extracted feature vectors to use in adapting the machine learning-based driver action prediction model.

13. The computing system of claim 9, wherein the local sensor data includes one or more of internal sensor data from sensors located inside a cabin of the vehicle, external sensor data from sensors located outside of the cabin of the vehicle, and network-communicated sensor data from one or more of adjacent vehicles and roadway infrastructure equipment.

14. The computing system of claim 9, wherein the local sensor data includes one or more of braking data describing braking actions by the driver, steering data describing steering actions by the driver, turn indicator data describing turning actions by the driver, acceleration data describing acceleration actions by the driver, control panel data describing control panel actions by the driver, vehicle-to-vehicle data, and vehicle-to-infrastructure data.

15. The computing system of claim 9, wherein adapting the stock machine learning-based driver action prediction model includes iteratively updating the stock machine learning-based driver action prediction model using sets of newly received local sensor data.

16. The computing system of claim 9, wherein
aggregating the local sensor data includes receiving localized data from one or more other adjacent vehicles reflecting local conditions of a surrounding environment surrounding the vehicle, and
adapting the stock machine learning-based driver action prediction model includes training the stock machine learning-based driver action prediction model using the localized data.

17. A computer-implemented method, the method comprising:
receiving a stock machine learning-based driver action prediction model prior to operation of a vehicle, the stock machine learning-based driver action prediction model having been initially generated using one or more generic training examples, the one or more generic training examples being configured to be applicable to a generalized set of users;
detecting a driver action of a specific user during the operation of the vehicle using local sensor data;
extracting, during the operation of the vehicle, features related to the driver action from the local sensor data;
generating, during the operation of the vehicle, training examples using the extracted features related to the driver action and the extracted features;
generating, during the operation of the vehicle, a customized machine learning-based driver action prediction model by updating the stock machine learning-based driver action prediction model using the training examples; and
predicting, during the operation of the vehicle, a future driver action using the customized machine learning-based driver action prediction model.

18. The computer-implemented method of claim 17, wherein the stock machine learning-based driver action prediction model is a neural network-based computer learning model.

19. The computer-implemented method of claim 17, wherein detecting the driver action includes generating a recognized driver action label using a machine learning based-recognition model.

20. The computer-implemented method of claim 17, further comprising:
linking the customized machine learning-based driver action prediction model to the specific user; and
providing the customized machine learning-based driver action prediction model to a remote computing device of a second vehicle for use in predicting future driver actions of the specific user relating the second vehicle.
